(19) United States
(12) Patent Application Publication
(10) Pub. No.: US 2018/0073657 A1
(43) Pub. Date: Mar. 15, 2018

(54) STRUCTURE FOR PREVENTING VIBRATION OF SOLENOID VALVE

(71) Applicant: HYUNDAI MOTOR COMPANY, Seoul (KR)

(72) Inventors: Se Kwon JUNG, Seoul (KR); Bu Kil KWON, Suwon-si (KR)

(21) Appl. No.: 15/383,597

(22) Filed: Dec. 19, 2016

(30) Foreign Application Priority Data
Sep. 12, 2016 (KR) 10-2016-0117052

(51) Int. Cl. F16K 31/06; F16F 7/09; F16F 13/00; F16K 47/02

(52) U.S. Cl. CPC F16K 31/0689; F16F 7/095; F16F 2222/04; F16K 47/02; F16F 2224/02; F16F 13/005

(57) ABSTRACT

A structure for preventing vibration of a solenoid valve includes: a plunger which opens and closes a flow path by moving inside the solenoid valve; a yoke attached to an inner surface of a valve core; and a friction member disposed along an outer circumferential surface of the plunger between the plunger and the yoke, in which the friction member presses the yoke between the yoke and the plunger.

### CROSS-REFERENCE TO RELATED APPLICATION

This application claims under 35 U.S.C. § 119(a) the benefit of priority to Korean Patent Application No. 10-2016-0117052 filed on Sep. 12, 2016, the entire content of which is incorporated herein by reference.

### TECHNICAL FIELD

The present disclosure relates to a structure for preventing vibration, which may be generated in a solenoid valve due to behavior of a plunger positioned in the solenoid valve during a process of supplying hydrogen from a fuel tank to a stack through the solenoid valve, and for preventing noise caused by the vibration.

### BACKGROUND

A fuel cell system reduces pressure of hydrogen supplied from a high-pressure fuel tank and supplies the hydrogen to a stack, and operations of opening and closing a flow path in a hydrogen supply line is generally performed by a solenoid valve.

In general, a solenoid valve is a device for opening or closing the flow path by changing an inlet or an outlet between a valve cylinder and a plunger by transmitting physical force in a predetermined direction using an electromagnet. The solenoid valve has been widely used in various industrial fields such as electric machines and electronic machines.

The solenoid valve, which performs the aforementioned functions, is mainly used to control a flow of fuel, that is, hydrogen in a flow path in a fuel cell system. In general, the solenoid valve, which is used to control a flow of a fluid, usually blocks a flow of hydrogen by closing the flow path as the plunger comes into close contact with a yoke at an outer circumferential portion of the plunger by elastic force of a restoring spring.

That is, because force caused by the flow of the fluid is higher than the elastic force of the restoring spring at normal times, the flow of the hydrogen is blocked in a state in which the plunger closes the flow path. However, when electricity is applied to a coil of the solenoid valve, the plunger is moved by a magnetic force, and at the same time, the flow path is opened. Therefore, a portion between the plunger and a solenoid valve seat is opened, and fluid, that is, hydrogen is introduced.

That is, when electricity is applied to the coil, a magnetic field is formed in the coil, and the magnetic field lifts up the plunger in a state in which the plunger is in close contact with the valve seat, such that a force higher than the elastic force of the restoring spring is applied. When no electricity is applied to the coil, the plunger comes back into close contact with the valve seat by the elastic force of the restoring spring.

The core is provided in the solenoid valve in order to perform an electromagnetic operation, and a bobbin around which the coil is wound is installed inside the core, and as a result, when electric power is applied to the coil, the plunger positioned in the core may be moved.

However, when high-pressure fuel having a pressure of about 9 to 20 bar flows into the valve at a high speed, the valve resonates in a vertical direction, which may cause severe vibration and noise. For this reason, there are problems in that the vibration and the noise have a severe adverse effect on noise reducing properties of a vehicle equipped with the fuel cell system, and performance in respect of controlling a flow rate of fuel in the flow path deteriorates.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure has been made in an effort to solve the above-described problems associated with the prior art, and to provide a structure in which a friction part is configured by inserting a friction member between drive units of a solenoid valve, that is, between a plunger and a yoke in the solenoid valve, and one side of the friction member may be attached to the plunger or the yoke. As the friction member and the yoke come into close contact with each other, the friction member may press the yoke. As the friction member presses the yoke, frictional force between the plunger and the yoke may be increased. Therefore, an object of the present disclosure is to provide a structure for reducing vibration and noise of the solenoid valve by generating damping by generating friction between the friction member and the yoke when the plunger moves.

According to an exemplary embodiment of the present disclosure, a structure for preventing vibration of a solenoid valve, the structure includes: a plunger which opens and closes a flow path by moving inside the solenoid valve; a yoke attached to an inner surface of a valve core; and a friction member disposed along an outer circumferential surface of the plunger between the plunger and the yoke. The friction member, which is positioned between the yoke and the plunger, presses the yoke.

A plurality of friction members may be disposed between the plunger and the yoke.

The friction member may further include cut out portions which are opened at one end. When both ends of the cut out portions are in direct contact with each other, the friction member may generate an elastic force in an outward direction.

The friction member may be attached to one side of an inner wall surface of the yoke and fixed to the yoke when the plunger moves.

The structure may further include a groove which is formed on the outer circumferential surface of the plunger. The friction member is fixed to the groove and moves together with the plunger.

The structure may further include a spring which is penetratively inserted into the plunger. The spring presses the friction member in a direction from the interior of the plunger to the yoke.

An outer diameter of the friction member and an inner diameter of the yoke may be equal to each other or may have a difference value within a preset range, such that as the friction member and the yoke are fitted with each other, the friction member presses the yoke.

The friction member may be made of a nonmetallic material.

The nonmetallic material may be any one selected from polymeric materials is or plastic materials that enable solid lubrication.

The friction member may be formed as a thin film having a thickness of between 0.1 mm and 10 mm.

According to the structure for preventing vibration of the solenoid valve according to the present disclosure, it is possible to more precisely control the movement speed of the plunger when the plunger moves.

Even under a condition of the vehicle equipped with the fuel cell system, in which a flow rate of the fluid passing through the valve in the flow path is rapidly changed such as a sudden change n output of the fuel cell or a sudden purge, it is possible to minimize noise caused by vibration and vibration of the valve which may be generated by resonance of the valve itself or an interaction with the fluid.

In particular, since the damping is generated by the frictional force in the solenoid valve, it is possible to prevent vibration and noise of the valve, and since the vibration and the noise, which have been already generated, are reduced, it is possible to improve marketability of the vehicle by minimizing an effect on the vehicle.

By controlling the frictional force between the plunger and the yoke while the plunger moves inside the solenoid valve, it is possible to prevent a stuck phenomenon in which the plunger is stuck in the yoke.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuel derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view illustrating a connection relationship of a fuel cell system in which a solenoid valve of the present disclosure may be mounted;

FIG. 2 is a view illustrating a state in which a friction member is formed between a plunger and a yoke in accordance with an exemplary embodiment of the present disclosure;

FIG. 3 is an enlarged view of a quadrangular part indicated by a dotted line in FIG. 2;

FIG. 4 is a view illustrating a cross section of the friction member and a direction in which elastic force is applied;

FIG. 5 is a view illustrating a spring and the friction member in a state in which the spring is formed to penetrate the interior of the plunger; and

FIG. 6 is a view illustrating a state in which a friction member is formed between a plunger and a yoke in accordance with another exemplary embodiment of the present disclosure.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents, and other embodiments, which may be included within the spirit and scope of the invention as defined by the appended claims.

Hereinafter, exemplary embodiments of the present disclosure will be described in more detail with reference to the accompanying drawings. The exemplary embodiments of the present disclosure may be modified in various forms, and the scope of the present disclosure should not be interpreted as being limited to the following exemplary embodiments. The present exemplary embodiments are provided to more completely explain the present disclosure to a person with ordinary skill in the art.

The term “unit”, “part”, “module”, or the like, which is described in the specification, means a unit that performs at least one function or operation, and the “unit”, “part”, or the like may be implemented by hardware, software, or a combination of hardware and software.

In an exemplary embodiment of the present disclosure, a fuel cell system may be mounted in a four-wheel drive vehicle, and is provided with a fuel cell stack, a fuel gas supply and discharge device, an air supply and discharge device, a coolant circulation device, and a control unit.

Referring to FIG. 1, in the present disclosure, a fuel cell system may include a fuel tank, a fuel cell stack, a pressure regulator which adjusts a pressure between the tank and the stack, and a fuel supply valve. The fuel supply valve may supply fuel to the stack from the fuel tank by being repeatedly opened and closed. The fuel supply valve may be configured as a solenoid valve, and hydrogen may be supplied as fuel. In detail, the fuel tank mounted in the fuel cell system may be filled with hydrogen with high pressure of 350 bar or 700. The pressure of the high-pressure hydrogen is reduced by the regulator to a pressure level of 9 to 20 bar, and then, the hydrogen is supplied to the solenoid valve.

As the solenoid valve mentioned in the present disclosure, it is possible to use a proportional control valve of which an opening degree is adjusted in accordance with electric current or duty applied to the valve. The proportional control valve may supply hydrogen from the fuel tank to the stack at a flow rate required in the fuel cell system by controlling the opening degree.

Because of its own high noise reducing properties of the vehicle equipped with the fuel cell system, even small vibration or noise generated in the solenoid valve may have an adverse effect on noise, vibration, and harshness (NVH) performance of the vehicle. Therefore, an operation of maintaining noise reducing properties of the solenoid valve while the vehicle equipped with the fuel cell system travels, particularly while the solenoid valve operates may be closely associated with NVH performance of the entire vehicle. In addition, when supplying the hydrogen to the fuel cell system, that is, when supplying the hydrogen from the fuel tank to the stack through the flow path, high-pressure and high-speed hydrogen gas flows into the solenoid valve and passes through the flow path, but the high-pressure and high-speed hydrogen gas may unstably flow in many instances. Therefore, vibration or noise caused by an interaction between the hydrogen gas and the solenoid valve is closely associated with noise reducing properties of the vehicle equipped with the fuel cell system.

To solve the aforementioned problems, an exemplary embodiment, a structure, and an operating method of the present disclosure will be described below in detail with reference to the drawings.

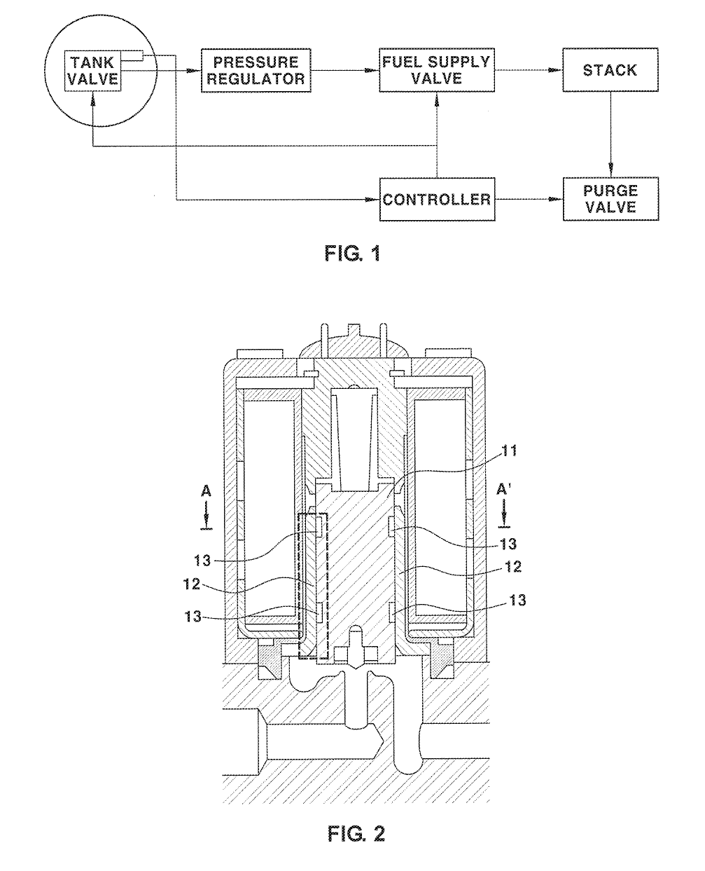

FIG. 2 is a view illustrating an exemplary embodiment of the present disclosure. In the present disclosure, the solenoid valve may include a solenoid, a core, a plunger 11, a yoke 12, valve core, and a valve holder as basic structures. The plunger 11 may be provided in the solenoid valve, and particularly, the plunger 11 may be repeatedly closely attached to or separated from a valve seat while moving vertically inside the solenoid valve. As the plunger 11 and the valve seat are closely attached to each other or separated from each other, the flow path between the fuel tank and the stack may be opened or closed.

The yoke 12 may be formed on an inner surface of the core. Also, the yoke 12 may be formed on an inner surface of the solenoid valve. In particular, the yoke 12 is fixed to an inner surface of the solenoid valve holder or an inner surface of the core. The valve holder may include the flow path through which the hydrogen gas flows from the fuel tank to the stack, and the valve seat. When electric current is applied to the solenoid, a magnetic field is formed, and the core and the plunger 11 are magnetized by the formed magnetic field, such that the plunger 11 is moved in a direction toward the core, and as a result, the valve may be opened. In this case, a flow rate of the hydrogen gas, which passes through the valve and is supplied to the stack, may be adjusted by controlling and adjusting a gap between a tip of the plunger 11 and the valve seat.

When a flow rate of the hydrogen gas, which flows into the solenoid valve and is supplied to the stack, is suddenly changed, vibration of the solenoid valve may be generated in a gap between the plunger 11 and the yoke 12 due to the interaction between the hydrogen gas and the plunger 11 of the solenoid valve.

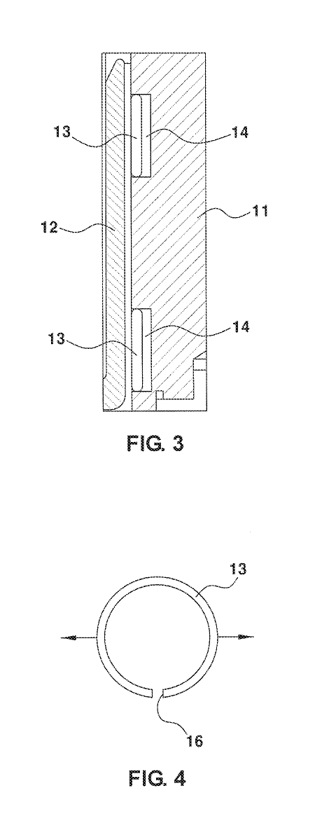

FIG. 3 is an enlarged view of a quadrangular part indicated by a dotted line in FIG. 2. In the present disclosure, friction members 13, which are formed along an outer circumferential surface of the plunger 11, may be provided between the yoke 12 and the plunger 11. A magnitude of frictional force between the plunger 11 and the yoke 12 may be adjusted by the number of the friction members 13, and one or a plurality of friction members 13 may be provided. A shape of the friction member may correspond to a shape of the outer circumferential surface of the plunger.

FIG. 4 is a view illustrating the friction member 13 in accordance with the exemplary embodiment of the present disclosure. The friction member may be formed to be opened at one end. The opened one end of the friction member 13 may be referred to as cut out portions 16, and particularly, the friction member 13 may be formed in an annular shape and has a structure in which the cut out portions 16 may come into direct contact with each other. Moreover, the friction member 13 may be formed as a member having elastic force when the cut out portions 16 are in direct contact with each other. In particular, the friction member 13 may have elastic force in a direction of an arrow illustrated in FIG. 4. When the cut out portions 16 of the friction member 13 are in direct contact with each other, force may be applied to the cut out portions 16, which are in direct contact with each other, in a direction in which the cut out portions 16 move away from each other by elastic force of the friction member 13. That is, when the cut out portions 16 of the friction member 13 are in direct contact with each other, elastic restoring force may be applied in a direction toward the outside of the friction member 13.

In the present disclosure, the friction member 13 may be provided between the yoke 12 and the plunger 11. In detail, the friction member 13 is formed along the outer circumferential surface of the plunger, and may be fixed to the outer circumferential surface of the plunger outside the plunger or inside the yoke. As the friction member 13 has elastic force in an outward direction, that is, in a direction from a center of the plunger 11 to the yoke 12, the yoke 12 may be pressed. The yoke 12 is pressed by the friction member 13, and as a result, when the plunger 11 moves inside the solenoid valve, the frictional force may be increased in the movement direction of the plunger 11. Due to the increased frictional force between the plunger 11 and the yoke 12, damping force is generated when the plunger 11 moves inside the solenoid valve, and the movement speed of the plunger 11 inside the valve may be controlled by managing the frictional force and the damping force within a designed range. In the case of the damping force in the present disclosure, force, which is frictional force that performs a damping function and prevents the plunger 11 from vibrating inside the cylinder of the solenoid valve, may be referred to as the damping force.

Ultimately, an operating speed of the solenoid valve may be controlled by controlling the movement speed of the plunger 11 inside the valve.

By controlling the operating speed of the solenoid valve, it is possible to reduce vibration of the valve or ensure a response speed at a level required by the system, and it is possible to prevent the plunger 11 from being in a stuck state in which the plunger 11 cannot be moved inside the solenoid valve.

Hereinafter, another exemplary embodiment of the present disclosure in which the friction member 13 is fixed at one side of an inner wall surface of the yoke 12 and the plunger 11 moves vertically will be described. As described above, the friction member 13 may be fixed in a state of being fastened to the yoke 12. In detail, the friction member 13 may be attached and fixed to one side of the inner surface of the yoke 12. In a case in which the friction member 13 is fixed to the yoke 12, the friction member 13 may press the plunger 11 in a direction from he yoke 12 toward the center of the plunger 11. That is, the friction member 13 may press the plunger 11 inward in a state in which the friction member 13 is fixed to the yoke.

As still another exemplary embodiment, the friction members 13 may be fastened to the plunger 11 so as to move integrally with the plunger 11, and particularly, the friction members 13 may be maintained in a state of being fixed to the plunger 11 by being caught by grooves 14 formed on the outer circumferential surface of the plunger 11. The grooves 14 may be formed along the outer circumferential surface of the plunger so as to correspond to the shape of the friction member, and as another exemplary embodiment, the grooves 14 may be formed at a predetermined interval along the outer circumferential surface of the plunger or may be formed at appropriate positions determined to be required. That is, the positions of the grooves 14 and the number of the grooves 14 are acceptable as long as the grooves 14 are formed on a part of the outer circumferential surface of the plunger within a range in which the friction member may be moved together with the plunger.

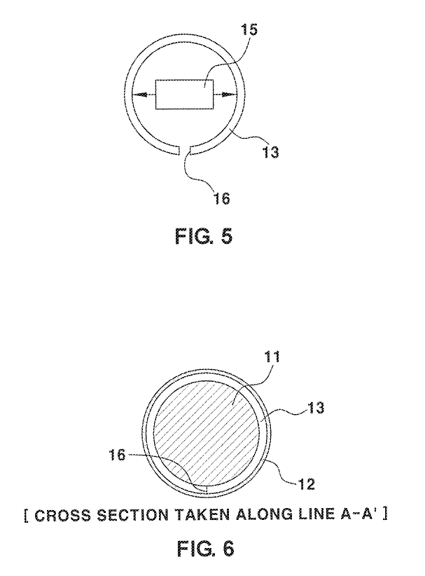

FIG. 5 is a view illustrating still another exemplary embodiment of the present disclosure. In FIG. 5, a spring 15, which penetrates the interior of the plunger 11, may be provided. In particular, in a case in which the friction member 13 is fastened to the plunger 11 and moves integrally with the plunger 11, the spring 15, which penetrates the plunger 11, may be provided at a position in the plunger 11 which corresponds to a height at which the friction member 13 is provided on the outer circumferential surface of the plunger 11. The spring 15, which penetrates the interior of the plunger 11, may be positioned to be co-planar with the friction member 13 formed on the outer circumferential surface of the plunger 11. Therefore, the spring 15, which is provided in the plunger 11, may press the friction member 13 in the direction from the center of the plunger 11 to the yoke 12. The direction in which the spring 15 is formed is not considered in principle as long as the spring 15 and the friction member 13 are positioned to be co-planar with each other, but particularly, as illustrated in FIG. 5, the spring 15 may be provided to apply elastic force in a direction parallel to a direction in which the cut out portions 16 of the friction member 13 are spaced apart from each other. Therefore, the elastic force of the spring 15, in addition to the elastic force of the friction member 13 itself, may press the yoke 12 in a radial direction from the center of the plunger 11. As a result, damping force may be generated by higher frictional force and friction between the plunger 11 and the yoke 12. In addition, in a case in which the spring 15 is provided in the plunger 11, the extent to which the friction member 13 presses the yoke 12 may be adjusted by adjusting the elastic force of the spring 15. Therefore, the frictional force between the plunger 11 and the yoke 12 may be adjusted.

As still yet another exemplary embodiment of the present disclosure, an outer diameter of the friction member 13 may be equal to an inner diameter of the yoke 12. Alternatively, the outer diameter of the friction member 13 and the inner diameter of the yoke 12 may have a difference value within a preset range. Therefore, when the friction member 13 is provided between the plunger 11 and the yoke 12, the friction member 13 may be fitted with the inner diameter of the yoke 12. As an exemplary embodiment, the friction member 13 may be fitted with the inner diameter of the yoke 12 in an interference fit manner and may press the yoke 12, and as a result, it is possible to expect the aforementioned effect.

In the present disclosure, the friction member 13 may be formed by using a nonmetallic material. In more particular, a polymeric material, which enables solid lubrication, may be used as a material of the friction member 13, and as an exemplary embodiment, the friction member 13 may be made of plastic. If the nonmetallic material or the polymeric plastic material is used, it is possible to prevent abrasion of the yoke 12 and the plunger 11, and to prevent an inflow of metallic foreign substances into the flow path or the stack which may be caused by abrasion of the friction member 13 itself. If the metallic foreign substances are produced and flow into the stack through the flow path, the metallic foreign substances may act as a metallic catalyst inside the stack. If the metallic foreign substances, which are produced by abrasion and flow into the stack, act as the metallic catalyst, degradation may occur in an MEA of the stack. If the MEA is degraded, the degradation of the MEA may have a fatal effect on driving performance of the stack, and accordingly, the prevention of the occurrence of the metallic foreign substances in the fuel cell system is a very important factor. Therefore, in the present disclosure, the configuration in which the friction member 13 is made of a nonmetallic material instead of a metallic material may be an important factor for implementing the invention.

Alternatively, as still yet another exemplary embodiment of the present disclosure, the present disclosure may be implemented by adjusting a thickness of the friction member 13 in order to minimize a thickness manufacturing deviation of the friction member 13. The thickness of the friction member 13 may be appropriately determined as necessary within a range between 0.1 mm and 10 mm. In particular, the friction member 13 of the present disclosure may be formed as a thin film having a thickness of 1 mm or smaller. When the friction member 13 is formed as a thin film having a thickness of 1 mm or smaller, it is possible to minimize a thickness tolerance between the plunger 11 and the yoke 12, and as a result, there may be an advantage in that the frictional force between the plunger 11 and the yoke 12 may be smoothly and easily adjusted.

FIG. 6 is a view illustrating still yet another exemplary embodiment of the present disclosure. FIG. 6 illustrates a cross section taken along line A-A′ of FIG. 2, and illustrates a state in which the cut out portions of the friction member 13 are in direct contact with each other between the plunger 11 and the yoke 12. Therefore, the state illustrated in FIG. 6 may be a state in which force is applied to the yoke 12 by the friction member 13 in the radial direction from a center of the plunger 11.

As described above, the key spirit of the present disclosure is characterized in that the friction member 13 formed between the plunger 11 and the yoke 12 of the solenoid valve such that the friction member 13 presses the yoke 12, and in detail, as the friction member 13 presses the yoke 12, the frictional force is increased when the plunger 11 moves, and as a result, the occurrence of vibration and noise of the solenoid valve is prevented and reduced by the damping caused by the increased frictional force. That is, the present disclosure is characterized in that the friction member 13 is provided, and the friction member 13 presses the yoke 12 in a direction from the plunger 11 to the yoke 12 by using various methods. Therefore, the aforementioned detailed descriptions exemplify the present disclosure.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A structure for preventing vibration of a solenoid valve, the structure comprising:
a plunger which opens and closes a flow path by moving inside a solenoid valve;
a yoke attached to an inner surface of a valve core; and
a friction member disposed along an outer circumferential surface of the plunger between the plunger and the yoke,
wherein the friction member, which is disposed between the yoke and the plunger, presses the yoke.

2. The structure of claim 1, wherein one or ore friction members are disposed between the plunger and the yoke.

3. The structure of claim 1, wherein the friction member includes cut out portions which are opened at one end, and
wherein when both ends of the cut out portions are in direct contact with each other, the friction member provides an elastic force in an outward direction.

4. The structure of claim 3, wherein the friction member is attached to one side of an inner wall surface of the yoke and fixed to the yoke when the plunger moves.

5. The structure of claim 1, further comprising:
a groove formed on the outer circumferential surface of the plunger,
wherein the friction member is fixed to the groove and moves together with the plunger.

6. The structure of claim 5, further comprising:
a spring which is penetratively inserted into the plunger,
wherein the spring presses the friction member in a direction from the interior of the plunger to the yoke.

7. The structure of claim 1, wherein an outer diameter of the friction member and an inner diameter of the yoke are equal to each other, such that as the friction member and the yoke are fitted with each other, the friction member presses the yoke.

8. The structure of claim 1, wherein the friction member is made of a nonmetallic material.

9. The structure of claim 8, wherein the nonmetallic material is any one selected from polymeric materials or plastic materials that enable solid lubrication.

10. The structure of claim 1, wherein the friction member is a thin film having a thickness of between 0.1 mm and 10 mm.

11. The structure of claim 1, wherein an outer diameter of the friction member and an inner diameter of the yoke have a difference value within a preset range, such that as the friction member and the yoke are fitted with each other, the friction member presses the yoke.
